(19) United States
(12) Patent Application Publication
(10) Pub. No.: US 2018/0308162 A1
(43) Pub. Date: Oct. 25, 2018

(54) Apparatus, Methods and Articles of Manufacture for Constructing and Executing Computerized Transaction Processes and Programs

(71) Applicant: Goldman Sachs & Co. LLC, New York, NY (US)

(72) Inventors: Hernan G. Otero, Huntingtion, NY (US); Steven B. Horn, New York, NY (US); John Tumilty, New York, NY (US)

(21) Appl. No.: 15/957,840

(22) Filed: Apr. 19, 2018

Related U.S. Application Data
(63) Continuation of application No. 09/823,125, filed on Mar. 30, 2001, now abandoned.
Application No. 09/823,125 is a continuation-in-part of application No. 09/773,139, filed on Jan. 31, 2001, now abandoned.
(60) Provisional application No. 60/241,807, filed on Oct. 14, 2000.

(51) Int. Cl. G06Q 40/04; H04W 4/00; G06Q 30/02; G06Q 30/06

(52) U.S. Cl. CPC G06Q 40/04; H04W 4/00; G06Q 30/06; G06Q 30/02

(57) ABSTRACT

Open-ended apparatus, methods and articles of manufacture for constructing and executing transaction processes and programs are shown. These apparatus, methods and articles of manufacture are primarily used in computerized trading processes. In the especially preferred embodiments, transactional algorithms may be dynamically created and used through “plug-ins,” which are executed by a logic engine in which uses various inputs and outputs to obtain necessary information, process the order, and execute the order.

### CROSS-REFERENCE TO RELATED APPLICATIONS

This application is related to provisional application U.S. Ser. No. 60/241,807, by Steven B. Horn, John A. Fanelli. Hernan G. Otero and John Tumilty, which disclosure is incorporated herein by reference; and

co-pending U.S. application Ser. No. 09/773,139, entitled “APPARATUS, METHODS AND ARTICLES OF MANUFACTURE FOR CONSTRUCTING AND EXECUTING COMPUTERIZED TRANSACTION PROCESSES AND PROGRAMS” tiled on Jan. 31, 2001, by Hernan G. Otero Steven B. Horn and John Tumility, which disclosure is incorporated herein by reference.

### FIELD OF THE INVENTION

This invention relates apparatus, methods and articles of manufacture for computerized transaction execution and processing. More particularly, this invention relates to apparatus, methods and articles of manufacture for client-server transaction execution and processing.

### BACKGROUND OF THE INVENTION

Computerized transaction execution and processing requires an enormous amount of time and resources. The time and resources are required because, in most instances, execution and processing are based upon customized implementations of the transaction.

Customized transaction implementations require new programming. New programming requires cost and effort—not only for the first attempt, but also for the debugging and testing processes. Moreover, once the program is debugged and released, real world implementations require yet further testing and debugging.

All this effort takes resources and time. It takes resources because the programmers must first develop the program with input from the users, and then the users themselves must test the program in the field, to ensure reliable operation. The effort required means that the users may be too busy doing their job to assist in programming efforts. Thus the program may not ever be developed. Moreover, by the time any particular program is developed, the markets may have shifted away from the initial transactional conditions that first provided the impetus for developing the program. For example, specific trading strategies are usually constructed and executed on a customized basis, yet by the time the program is developed for those strategies, and those strategies are executed, they may be no longer useful.

The cost, effort and time factors are not solely the result of required programming. In trading transactions, the programmers must be advised by the traders or other business professionals regarding desired trading strategies and desired markets. These professionals are busy in their own right—they may have little or no time to advise the programmers on what new strategies and markets should be developed. Even if they can advise the programmers, trading strategies can become quite complex, and in order to communicate those strategies and implement those strategies effectively, the programmer and trader interactions cost time, money and resources.

Enterprise-wide customization adds yet another level of time, effort and complexity. What may be useful in one enterprise business unit may not be useful in another, and time, effort and resources may not be available to implement specific programs customized for each business unit.

Finally, any implementations most be quite robust, and reliably and consistently execute trading strategies. The implementation of new computerized transactional programs must be as close to bullet proof as possible—failure of a trading program can mean losses in thousands, millions or even billions of dollars. Developing reliable implementations of trading programs means that testing procedures and recovery procedures must always be paramount considerations.

Accordingly, it is an object of this invention to provide apparatus, methods and articles of manufacture for constructing and executing transactions.

It is a farther object of this invention to provide open-ended apparatus, methods and articles of manufacture for constructing and executing transaction processes and programs.

It is a further object of this invention to provide robust and reliable apparatus, methods and articles of manufacture for implementing trading strategies.

### BRIEF DESCRIPTION OF THE DRAWINGS

FIG. 1 is a schematic diagram of a preferred embodiment.

FIG. 2 is a schematic diagram of a preferred embodiment.

FIG. 3 is a screen shot of a preferred embodiment.

FIG. 4 is a screen shot of a preferred embodiment.

FIG. 5 is a screen shot of a preferred embodiment.

FIG. 6 is a schematic diagram of a preferred embodiment.

FIG. 7 is a schematic diagram of a preferred embodiment.

FIG. 8 is a flow chart of a preferred embodiment.

FIG. 9 is a flow chart of a preferred embodiment.

FIG. 10 shows components of a preferred embodiment.

### SUMMARY OF THE INVENTION

The present invention provides apparatus, methods and articles of manufacture for open-ended construction and execution of computerized transaction processes. In the preferred embodiments, an engine is used that permits “plugs-ins” to be used for construction, modification and alteration of trading procedure execution. These plug-ins can be preconstructed, or constructed when appropriate, and applied to the engine when desired.

In the preferred embodiments, the plug-ins comprise two types. The first type comprise algorithms used in trading. The second type comprise market-specific rules. Thus, for example, in the preferred embodiments, the engine can be configured with a specific algorithm and for a specific market for a first trade and then modified for another specific algorithm and another specific market for a second trade. In the especially preferred embodiments, the engine will carry out a number of trades using a specific algorithm, which has been chosen from a set of preconfigured algorithms. Moreover, the market plug-ins, having been set upon installation for use in a particular market, will be maintained for a predetermined or static period of time.

In the especially preferred embodiments, the orders that result from the plug-ins are executed by a logic engine which uses various interfaces in the form of inputs and outputs to assist in processing orders. Complex orders are processed through deconstruction; breaking down complex orders into simple orders. Messaging and queuing is used throughout the preferred embodiments to ensure stability when executing orders.

### DETAILED DESCRIPTION OF THE PREFERRED EMBODIMENTS

The preferred embodiments of the present invention provide apparatus, methods and articles of manufacture that have a number of characteristics in order to provides open-ended construction and execution of computerized trading processes. The preferred embodiments are constructed in Java which is essentially a platform independent language. Standard Java features are used in order to permit consistency among various Java versions. Javadocs, as well as the tracking application CVS, permits convenient tracking of modifications and revisions of these embodiments. Of course, other embodiments may be translated into other languages. Therefore, the embodiments may be used across a wide variety of networked platforms.

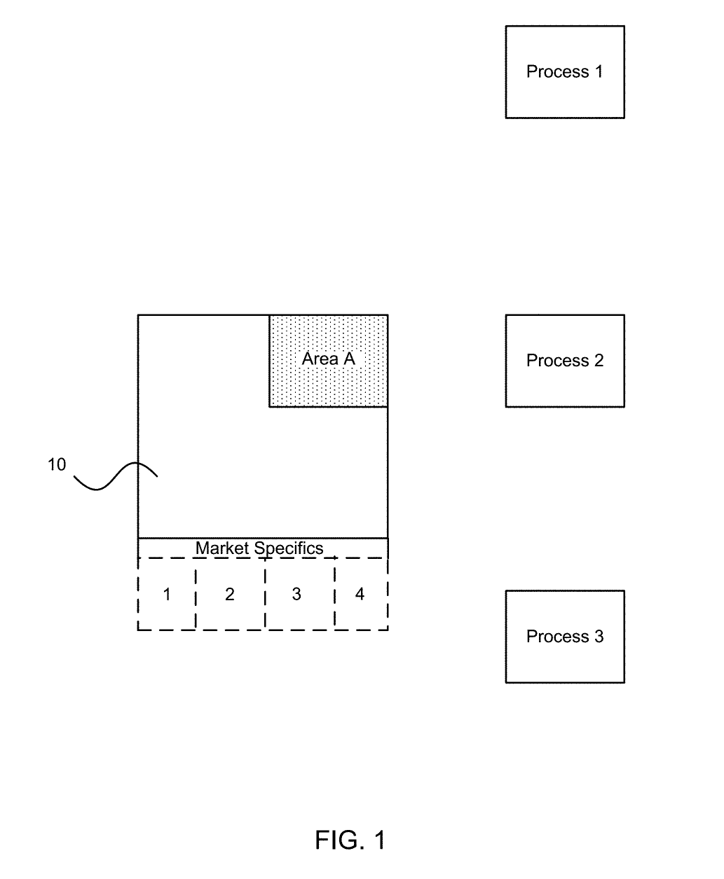

FIG. 1 shows a schematic diagram of a preferred embodiment. At 10 is shown the engine infrastructure of the preferred embodiment. Written in Java, and present on the server, this software enables various data, plug-ins, applications, processes, and algorithms to be used in order to customized the trading process. These data, plug-ins, applications, processes, and algorithms are imported or plugged into the engine as desired in order to implement a particular trading strategy.

Seen in FIG. 1 are various processes to be used in the engine 10. Area A of engine 10 symbolizes the area in which the plug-ins can be placed. Also seen at 10 is an area labeled “Market Specifics.” This area, also supporting customization through data, plug-ins, applications, processes, and algorithms permits customization of any particular algorithm for any particular market in a manner explained in further detail below. In other embodiments, the plug-ins used for the various areas can be internal or external to the engine. Hereinafter, “plug-ins” will be used as a general term for data, plug-ins, applications, processes, and algorithms.

Engine 10, in this embodiment, provides services for the plug-ins. For example, most trading strategy plug-ins will need to access market data. Most trading strategy plug-ins will need to send orders to the exchange and be notified of executions, etc. Engine 10 provides these and other services to the plug-ins. For example in a preferred embodiment, engine 10 provides:
A real time market data feed driver (e.g. Reuters SSL, TIB/Rendezvous feeds.)
An exchange driver where the algorithm sends orders and receives executions back.
A driver implementation that sends orders to one or more order management architecture(s) and/or system(s) server(s) is provided.
An input driver which enters requests to the engine 10.

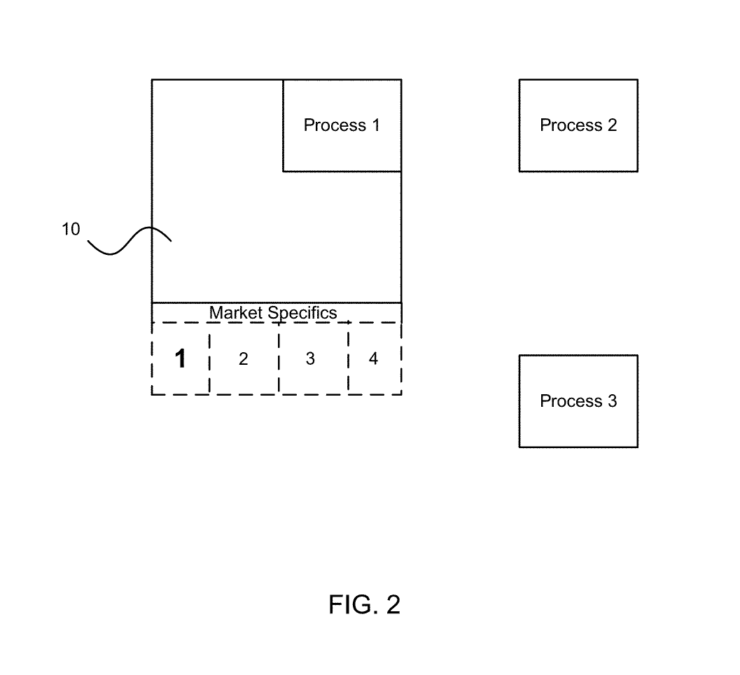

FIG. 2 shows Process 1 implemented in engine 10. Process 1 might be a trading process such as Volume-Weighted-Average-Price or VWAP. The VWAP algorithm used in this embodiment, attempts to match the VWAP for a given instrument, such as an equity throughout a specified lifespan (e.g. throughout the full trading day). VWAP will maintain a number of limit orders in the market at different price levels. In order to trade according to the VWAP algorithm of this embodiment, the engine will listen to market data throughout the day and access a volume profile to match the day's VWAP as close as possible.

The trader will then be able to review, through his screen, the order as it is being executed according to the VWAP algorithm. Any updates and/or change will be simply made through his or her screen.

If a second VWAP algorithm was desired to be used, such as one that is based on theoretical values to trading, this second plug-in can be substituted for the first in the engine. This second plug-in will then be used by the engine.

Returning to FIG. 2, the Market Specifics plug-in 1 has been chosen. Market specifics provide specific variables, data and other plug-ins necessary for the specific market in which the embodiment is being used. For example, they may be different limits on trading volume in one market versus another. The preferred embodiments permit configuration and modification of these Market Specifics, by plug-ins, so that they may be used in a variety of markets as desired.

In the preferred embodiments, the plug-ins comprise two types. The first type comprise algorithms used in trading. The second type comprise market-specific rules. Thus, for example, in the preferred embodiments, the engine can be configured with a specific algorithm, such as a first VWAP algorithm and for a specific market for a first trade such as the New York Stock Exchange and then modified for another specific algorithm such a Ratio algorithm and another specific market such as the Tokyo Stock Exchange for a second trade. In the especially preferred embodiments, the engine will carry out a number of trades using a specific algorithm, which has been chosen from a set of preconfigured algorithms. The algorithm used may be parameterized by the trader, in order to execute specific trades for a specific stock, price and number of shares. In these embodiments, the algorithm plug-in used is usually consistently used for that implementation of the embodiment during that particular trading period—whether it be an hour, day, week, etc. Of course, other embodiments may change their algorithm during any particular trading period. Moreover, the especially preferred embodiments usually maintain the market plug-in for at least the trading period, and usually longer. A trader, for example, may trade exclusively on the New York Stock Exchange using a preferred embodiment. Note that, using the especially preferred embodiments, the trader will change the algorithm plug-in, embodying his or her trading strategy, much more frequently than his or her market plug-in, as he or she may only trade in a particular market. Network or enterprise wide implementations, however, will use the market plug-in in order to configure any particular implementations for traders in the various trading markets.

This embodiment also effectively provides real-time monitoring of the order by the trader as well as others such as the sales force who desire to monitor the order and its execution. Additionally, orders are fully integrated, and so the trader or others may override individual orders through the system of this embodiment, without an additional messaging system. Similarly, any changes to an order, such as size of the order or a price limit or volume can be echoed to the system of this embodiment and the system will automatically adjust its trading to the new parameters.

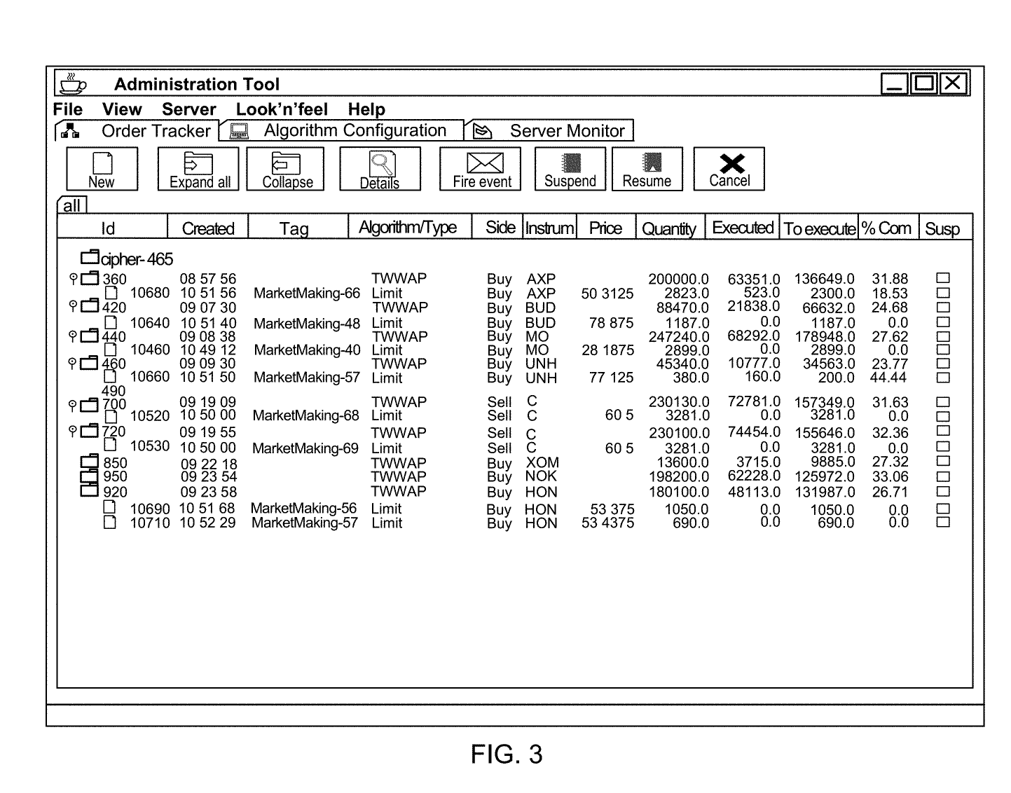

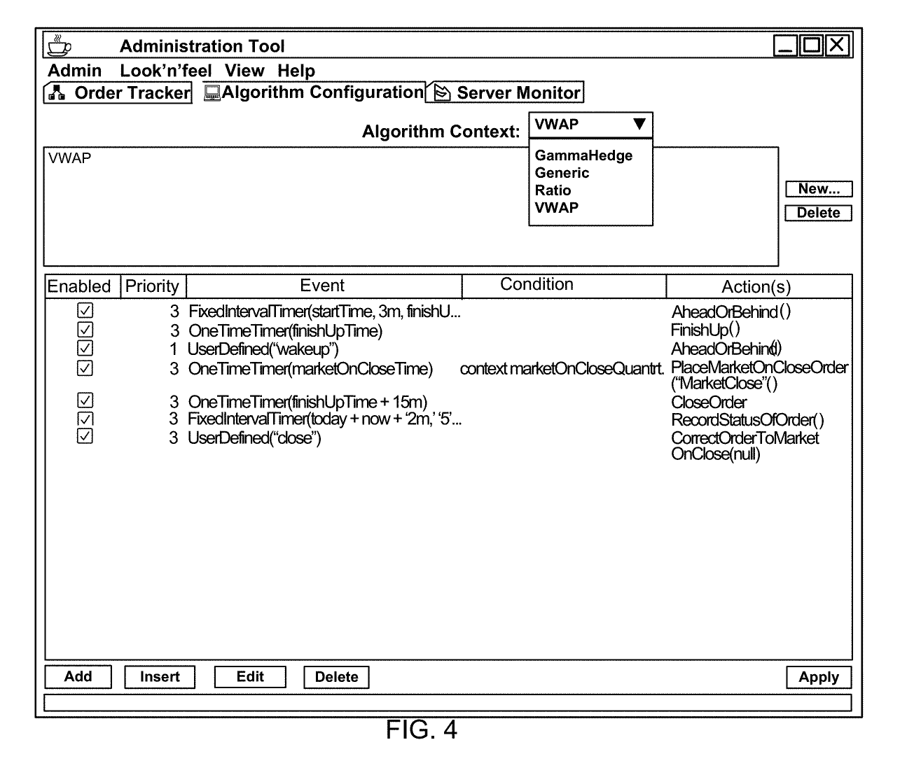

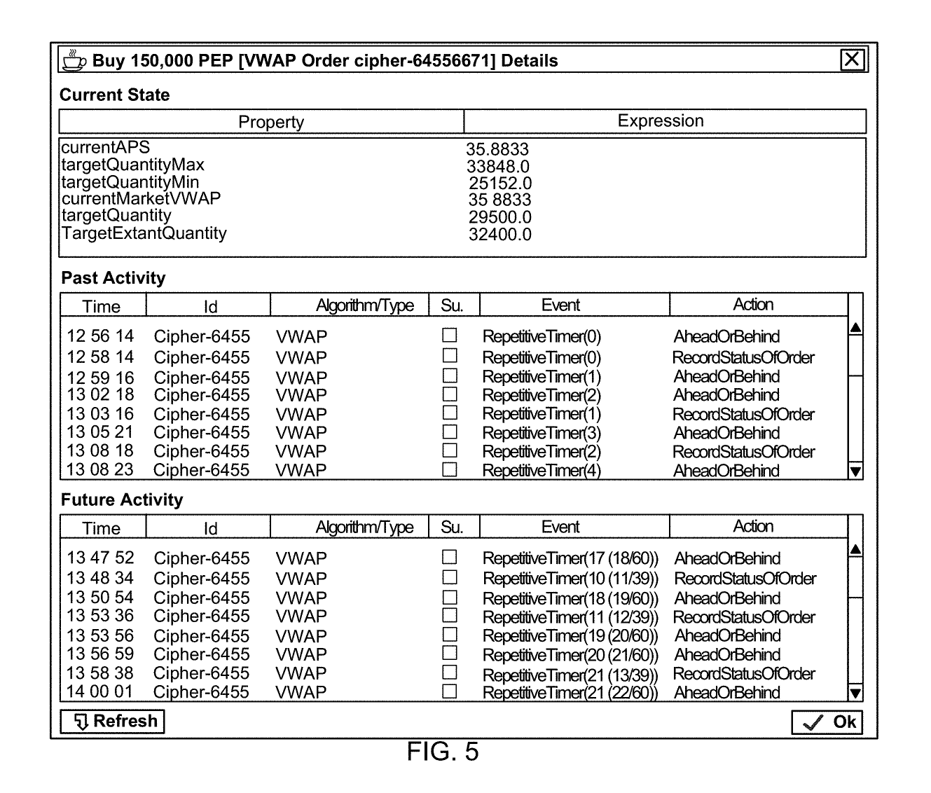

Various screen shots or the administration and monitoring tool GUI (written in Java, using Swing) used in a preferred embodiment are shown at FIGS. 3 through 5. These are an Order Tracker screen shown in FIG. 3, an Algorithm Configuration screen shown in FIG. 4, and an Order Details screen shown in FIG. 5. This tool allows for configuring algorithms as well monitoring the server. This tool may be installed on either or both of the client and server machines and on more than one machine in the networked environment.

In the preferred embodiments, an algorithm is comprised of an Algorithm Context, which may be a Java Class, plus a set of event-action mappings. These algorithms are usually written by a programmer. The mappings may be modified by non-programmers (e.g. a trader) via the graphical tool. The mappings provide a powerful way to fine tune the algorithm. Of course other embodiments may modify the mappings in a different fashion. For example, the programmer may provide the trader or other end user with objects that constitute events, conditions and actions. The trader can then construct his or her own algorithms which are plugged into the invention in order to provide the trader with an automatic execution mechanism.

Other algorithms that may be used in this embodiment include:
Ratio which tries buy an instrument and sell a related instrument when the price between the two is more favorable than a specified ratio.
Gamma Hedge which hedges a portfolio and tries to capture volatility while doing so.
Aggressive Short Sell which tries to short sell a given instrument by making sure the Tokyo short sell rule is not violated.
Stop Loss which allows sending stop loss orders to exchanges that do not support this concept.
Iceberg which tries to trade a specified number of shares by sending only a part of the total order's quantity (the tip of the iceberg) to the market at any given time.
Auto Trader which decides whether to send trades to the market or fill from an account.
CB Belts Hedge which sends out underlyer market orders to hedge CB trades.

Of course, other algorithms or plug-ins may be used. Additionally, in the preferred embodiments, preferred methods of constructing and implementing new plug-ins are used. The preferred embodiments also use several Java features, e.g. introspection, reflection and the like, in order to automatically discover properties of the imported algorithms.

If new algorithms are desired, a number of methods can be used to create the algorithm. In this embodiment, if the new algorithm requires no Java code, then the algorithm can be created by leveraging on existing algorithm context classes. Specific classes have been established or predetermined in the preferred embodiments. If the new algorithm is simple enough, it can be created without writing any Java code, making use of the Administrator GUI. This can he done by simply creating a set of event-action mappings that will work on a pre-existing algorithm contest class (e.g. the base AlgorithmContext class that is part of the preferred embodiments core classes).

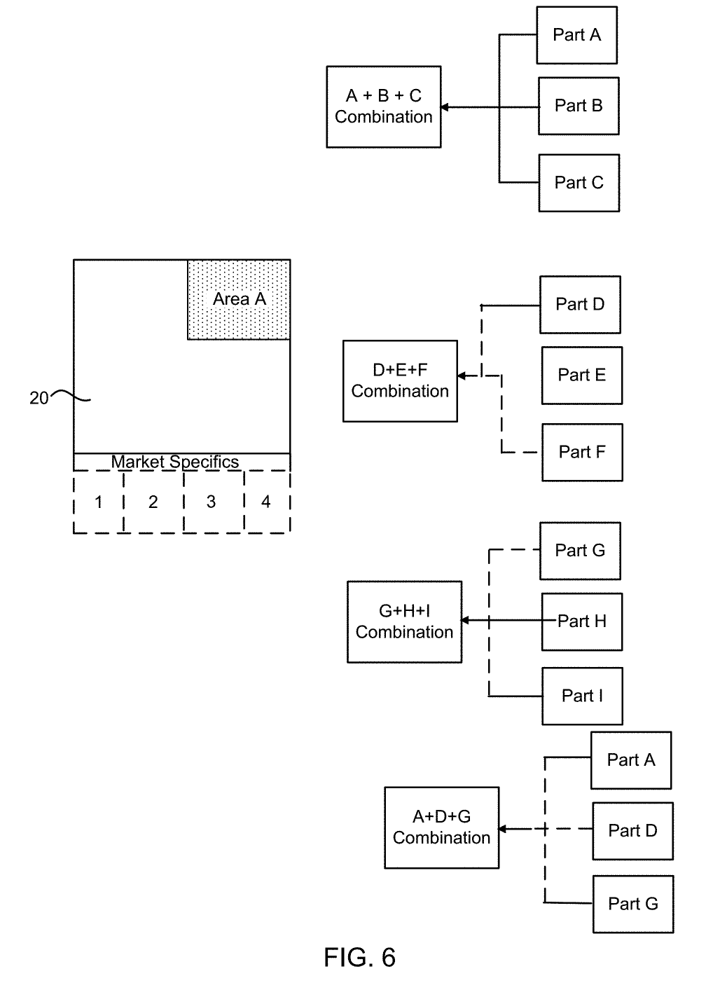

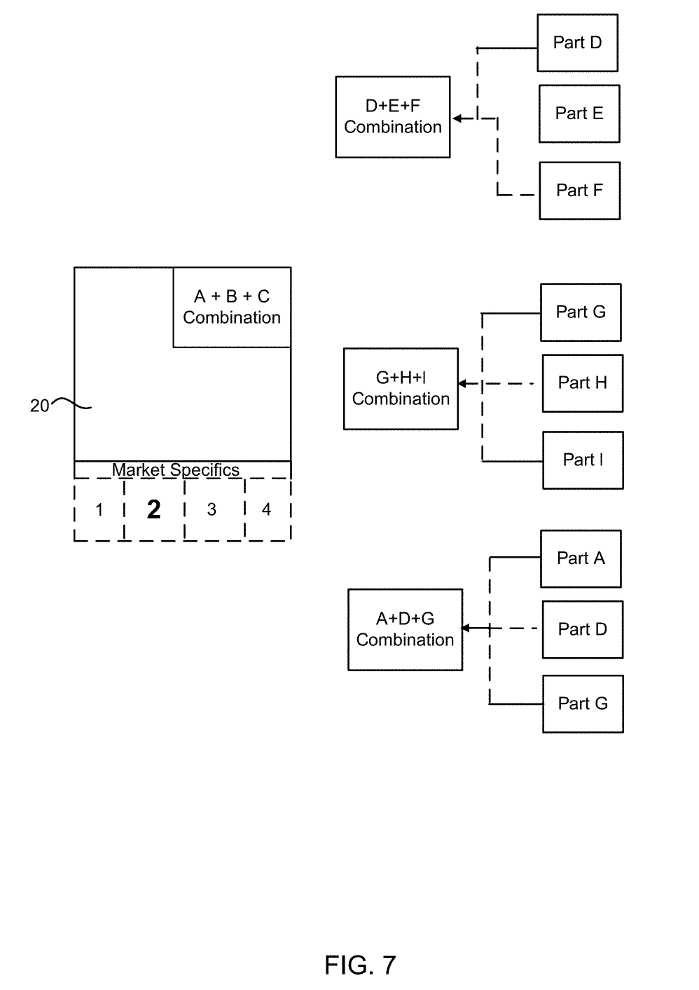

FIGS. 6 and 7 show how various mappings or parts may he used to construct combinations. Those combinations, constructed in FIG. 3, are then inserted into the engine 20 in FIG. 7. Note that a different Market Specifics plug-in, Market Specifics 2, has been chosen in FIG. 7. These Market Specifics plug-ins may be from a predetermined set. In the especially preferred embodiments, the market plug-ins is usually maintained over some static trading period. A trader, for example, may trade exclusively on the New York Stock Exchange, using the market plug-in. In enterprise installations, the market plug-ins may be set for the particular trading markets across the enterprise, and remain as set for a predetermined or static period of time.

If the new algorithm requires writing new code, the fundamental classes within the architecture of the preferred embodiment are: AlgorithmContext, Action, ActionBindings, ActionDispatcher. New Actions might be needed, for new complex algorithms, in order to do simple tasks that the existing actions can not deal with. Algorithms which require saving state during the execution of the order, for example, need to have their own Algorithm Context subclass. The data will then be kept in this new subclass.

The following process is used in the preferred embodiment to write code for a new algorithm. A Simple Algorithm Context must be written, starting with a template of what the class should look like, providing an empty, public constructor, adding in member variables, and providing a public getter/setter pair. Since this preferred embodiment makes use of beans support classes to access properties, JavaBeans conventions are used when naming these methods.

It is important to note that, in the preferred embodiments, traders provide vital feedback and oversight. Moreover, the embodiments evolve through use. There may be a lengthy tuning and feedback phase of algorithm development. The embodiments fit within a scalable architecture, and as the algorithms become more complex and widely used, the embodiments adapt and scale. Additionally, the embodiments must have fast Release Cycles. The preferred embodiments are flexible and separate the algorithm from the engine. Also, the algorithm should be as orthogonal as possible to the rest of the system. By use of this structure in the preferred embodiments, the embodiments can be used to trade and transact across virtually any instruments or exchanges.

In the preferred embodiments, the algorithms are tested for use. Of course, in other embodiments testing may not be desired. There are two main testing stages in a preferred embodiment. The first stage involves soliciting feedback with the traders and salespeople using the algorithm. The algorithm will not work right the first time, situations will not have been thought of, parameters will be wrong, failsafes will not be good enough and so on. The feedback at this early stage of development ensures not only a quick release but also that modifications can be made in situ.

The second stage of testing in this embodiment involves the continued evolution and updating of an algorithm once it is in production. It is important to have a very extensive series of tests that cover a multitude of trading situations. When changes are made to an algorithm, no matter how slight, every test is run and verified. This is necessary for production systems with it large number of users. Without high confidence that any changes made will not have any unforeseen follow-on effects, the release cycle becomes intolerably long. Of course, other embodiments may utilize different testing methods, including providing sample market feeds rather than real time feeds. The term “executing a trade” and its variants as used herein is meant to cover both actual and simulated execution of a trade.

The preferred embodiments implement a recovery mechanism, which assists the programmer in analyzing and/or recovering from crashes. The recovery process restores execution of orders by taking a number of steps. Those steps comprise:
Recovering the state of the orders. This involves rebuilding the order hierarchy (parent/child relationships, executed quantities, etc.) as it existed prior to the crash.
Recovering the exchange information. This involves making sure that all executions/corrections/cancellations that might have been pending when the embodiment crashed and had taken place during its blackout now get reflects in the embodiment's order hierarchy. This is done so that that future algorithm decisions get based on the current state of the world, and not the one present before the crash.
Restarting all algorithms. This is now possible since the algorithms will have their information up-to-date in order to make correct decisions on how to continue their execution. Depending on the complexity of the algorithms involved, this step may be as simple as setting up the event-action mappings for the algorithm context.

The recovery process in this embodiment includes writing to log or journal file. Of course other embodiments may have other recovery processes or recovery steps.

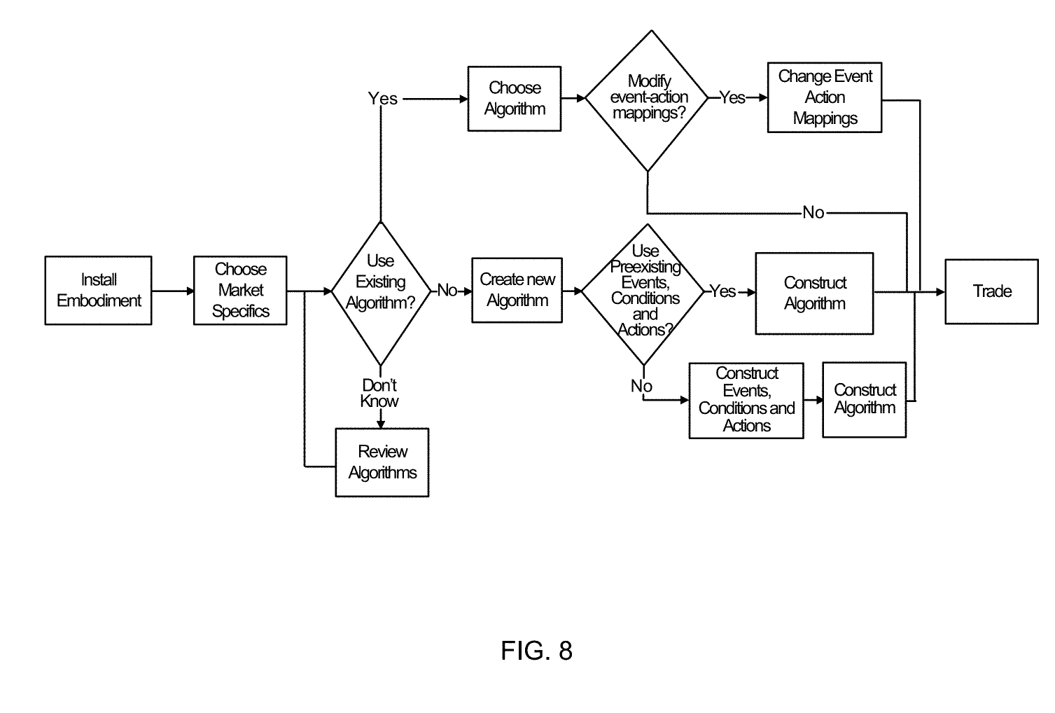

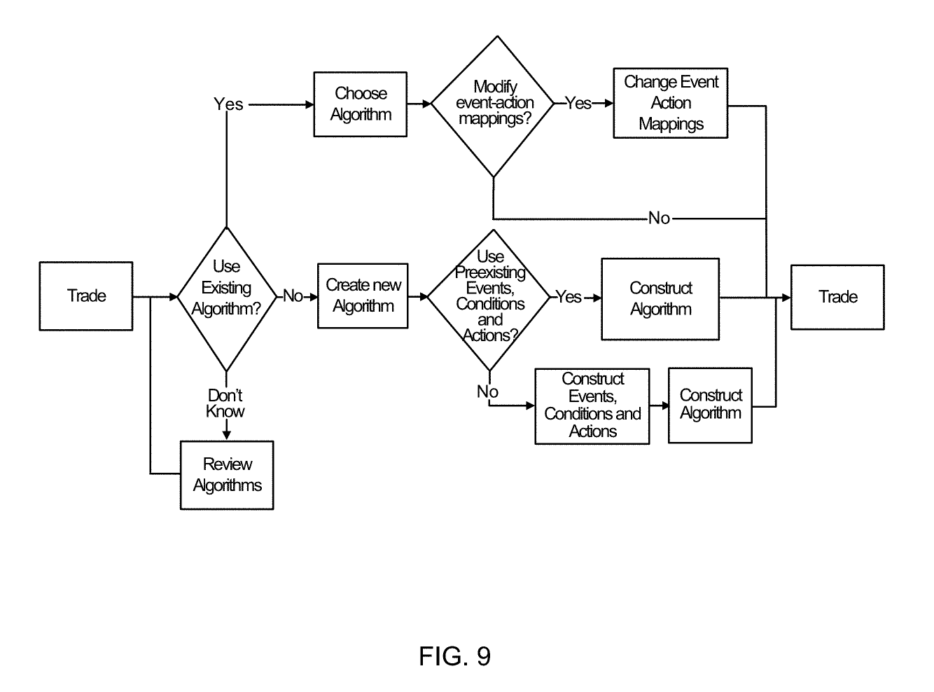

FIG. 8 provides a flowchart summarizing processes of a preferred embodiment, from installation to trading. FIG. 9 provides a flowchart summarizing a process for changing a plug-in. Other embodiments may have these processes or other processes with the same or similar steps in these or other orders.

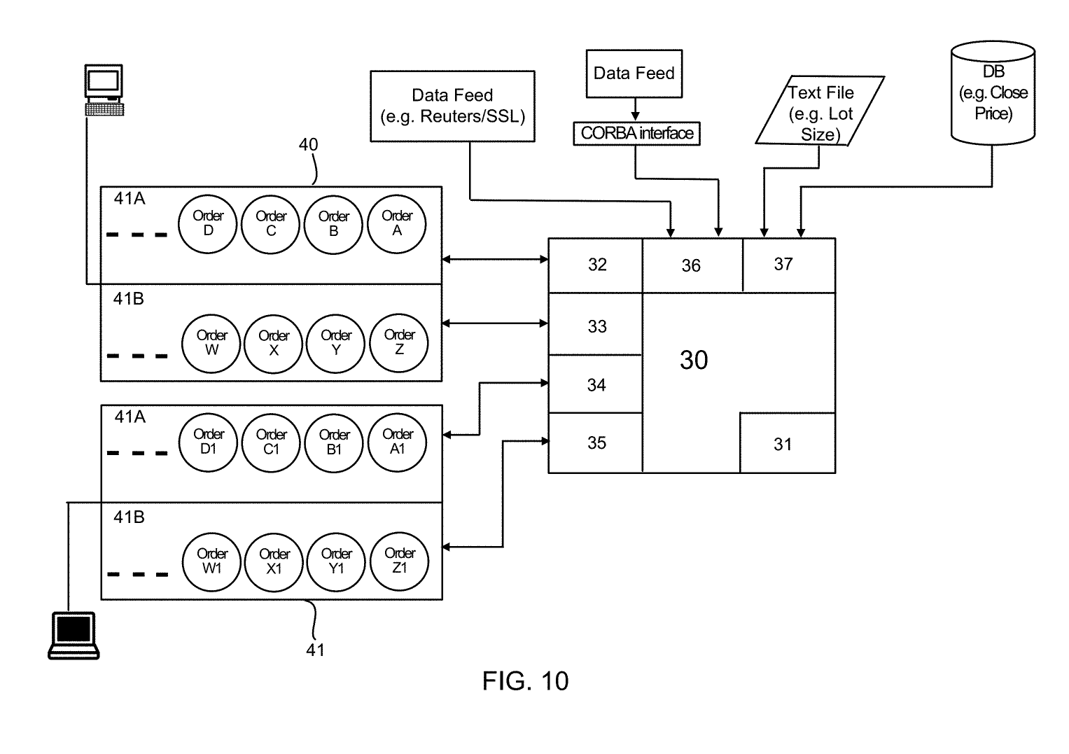

FIG. 10 shows a schematic diagram of an especially preferred embodiment. The Core Processing Area 30 is, in this embodiment, the logic engine which processes the order. The Core Processing Area 30 is shown with various interfaces in the form of inputs and outputs. The especially preferred embodiments of the present invention accept input and output from a variety of sources. The sources may change according to the embodiment and in the especially preferred embodiments, the nature of the financial instrument traded (e.g. a particular stock, bond, etc.) helps determine the input and output sources. (It should be noted that input includes is not limited to inputting data feeds, as well as data blocks, such as for example retrieving messages from a message queue. Output includes but is not limited to outputting data feeds as well as data blocks, such as for example outputting messages to a message queue.)

The embodiment of FIG. 10 is configured for trading stocks on the New York Exchange by way of Market Plug-In 31. Stock orders are entered into Ordering System 40 and/or Ordering System 41 (and any other ordering system that may be used) by a trader or another (“trader”) using a Graphic User Interface (“GUI”). The GUI provides the trader with the option of selecting various algorithm plug-ins to be used. The ordering system in turn interfaces with the logic engine, or in the embodiment of FIG. 10, with the Core Processing Area 30.

At order may be one of two types. One type of order, SimpleOrder, uses simple actions, such as Limit orders (e.g., “Sell 15,000 shares of Microsoft at 35”) or Market orders (e.g., “Buy 10,000 shares of Sun at Market”.) SimpleOrders are, in this embodiment, not sent to the Core Processing Area 30. Rather, they are executed by some other mechanism, such as by the ordering system, e.g., by 40B or 41B of the Ordering Systems 40 or 41 in FIG. 10.

A second type of order, ComplexOrders, uses higher level algorithms such as Volume Weighted Average Price; Ratio; Gamma Hedge; Aggressive Short Sell; Iceberg; Auto Trader; CB Delta Hedge; Stop Loss; and Short Sell. ComplexOrders usually comprise one or more Suborders. These Suborders can be either other ComplexOrders (which can have further suborders, possibly several levels deep) or SimpleOrders.

For example, assume trader places, a ComplexOrder using a Ratio algorithm:

BUY 10,000 SUNW and SELL 15,000 MSFT whenever the Ratio between the two exceeds 1.2

This order can be deconstructed into two separate Actions, buying 10,000 shares of Sun and selling 15,000 shares of Microsoft, whenever a certain Event happens (the price of Sun over Microsoft exceeds 1.2.) Therefore, this ComplexOrder can be processed by the Core Processing Area 30, into two SimpleOrders, each with an Action (e.g. buying 10,000 shares of Sun linked to an Event (e.g., when the price of Sun over Microsoft exceeds 1.2.) The two SimpleOrders can then be returned to the Ordering System through an appropriate output driver as is seen in FIG. 10 with regard to, for example, Output Driver 33 and Ordering System 40B.

As can be seen by the above example, higher level algorithms used by Complex/Orders can be comprised of Events and Actions. Once the ComplexOrders are processed to Events and Actions by the logic engine of the preferred embodiments, each Even and Action can be repackaged and executed as a SimpleOrder.

Returning now to FIG. 10, Ordering System 40 and Ordering System 41 interface with Core Processing Area 30 through input drivers and output drivers as described below. As the orders are entered into Ordering System 40, they form a queue in section 40A of Ordering System 40. The orders are then retrieved from the queue by Input Driver 32. Similarly orders from Ordering System 41A are retrieved by Input Driver 34. It should be noted that input drivers are configured according to the input data configuration, and the information input may vary based upon the instrument traded, the user'desires, etc. (The word “driver” and its variants are used herein to mean any code or data interface.) Other embodiments, may accept different inputs, through different inputs drivers. In these embodiments, the drivers may change as the instruments and/or the nature of the trade changes.

Some of the preferred embodiments are able, if they need to, to off-load any computationally intensive calculations, by using a distributed processing module, which proceeds, by messaging amongst the components, such as messaging the results of calculations from a calculation component to the Core Processing Area. This off-loading allows more efficient attention to the ordering tasks. Distributed processing also permits for use of “dynamic” constants in executing a complex order. Dynamic constants as that term is used herein are numbers that are used in an algorithm as constants, but also may change during the lifetime of the algorithm. For example, an off-hoc component may calculate certain alphas, used as constants, for an algorithm. These constants are then sent to the Core Processing Area to be used in future calculations of that particular algorithm. Thus, with a distributed processing system, the alphas may change, but the underlying algorithm remains the same.

Other inputs to the Core Processing Area 30 provide information necessary to execute the inputted orders by providing information on external conditions that may cause the Events and Actions of the order to be met. For example, in order to execute the Sun-Microsoft ComplexOrder example described above, the price ratio of Sun to Microsoft must be calculated by the Core Processing Area 30. In order to calculate the price ratio, the prices of Sun and Microsoft are provided to the Core Processing Area 30 by the data feed drivers.

In the embodiment of FIG. 10, Data Feed 36 accepts information from “dynamic” data feeds (those real rime feeds that typically change in fractions of a second), e.g. Reuters SSL, TIB/Rendezvous, etc. Data Feed 36 also accepts indirect input through intermediary interfaces. FIG. 10, for example, shows a CORBA (Common Object Request Broker Architecture) interface into Data Feed Driver 36. The CORBA interface, in turn, collects various market data feeds.

Another input type is static or semi static information flows, e.g., a text file with instrument lot sizes, a database with closing prices, etc. In the embodiment of FIG. 10, this input occurs by way of Instrument Information Driver 37. The instrument information driver provides a mechanism to update information from its sources if necessary. For example, a database with stock closing prices will be updated at the close of the trading session. In the preferred embodiments, updating may occur manually or automatically. Multiple drivers can also be set up to locate information about a particular instrument from different data feeds (e.g., stock pricing, options pricing for that stock, etc.)

It should be noted that the exemplary feeds described herein are used in the preferred embodiments described here, however, in other embodiments these and/or other data feeds with associated drivers, if necessary, may be used.

Also shown in FIG. 10 are two Exchange Drivers 33 and 35 for Ordering Systems 40 and 41 respectively. These output drivers are responsible for sending any orders created by the Core Processing Area 30 to the ordering systems for execution, as will be explained in further detail below.

A Complex Order is executed in the preferred embodiments by use of queues. An input driver retrieves a Complex-Order object from an order queue. The ordering system will have identified the algorithm used by the Complex Order so that the Core Processing Area may wrap the order in a corresponding AlgorithmContext object instance. (The corresponding AlgorithmContext instance is based on the algorithm name specified by the order.)

The AlgorithmContext object will first register itself with specific event interests. Event interests are those relevant to the particular algorithm and the particular ComplexOrder. So, for example, if the order contains the event “The price of Sun over Microsoft exceeds 1.2” that specific AlgorithmContext object will register the order with an Event interest object.

It should be noted that a complex ComplexOrder may be used, such as one that contains a multi-instrument order with multi-algorithms. In such an event, an AlgorithmContext Container object created. This object wraps other AlgorithmContexts within it. The AlgorithmContext Container will then forward all order creation requests to its internal AlgorithmContexts. The instrument identification field for each algorithm provide the necessary identification for proper forwarding. In other embodiments, such as for example when a multi-instrument single algorithm is used, another field besides the instrument identification field may be used to identify the appropriate AlgorithmContext.

Event interests exist in this embodiment to provide a placeholder to an event. A placeholder is needed between the AlgorithmContext object and the event because the event may not exist at the time the order has been input. For example, the Sun-Microsoft price ratio event called for by the above example does not exist. Therefore, any direct call for the event by a AlgorithmContext object would be invalid. Accordingly, an Event Interest object is created instead, which will await the event.

Events may be generated internally, in the Core Processing Area, or be input by way of external sources, or both. So, for example, the Ratio event “The price of Sun over Microsoft exceeds 1.2” is generated internally, as a product of events from external sources. The external sources provide the price tick events, updated through “dynamic” data feeds, that allow the internal calculation and generation of the Ratio event. If the Ratio event reaches the proper level, (“1.2” in the above example) the Algorithm/Context is notified.

Once the events are registered tor the particular AlgorithmContext instance, the actions for any particular AlgorithmContext instance will be executed when the events occur. In order to execute the actions for a particular AlgorithmContext, an ActionDispatcher object is used. This object receives requests for dispatching actions when the event occurs and places the actions on an internal, queue. So, for example, an ActionDispatcher object might receive an event, e.g. “The price of Sun over Microsoft exceeds 1.2” . . . and place the corresponding action, e.g. “Buy 10,000 shares of Sun; sell 15,000 shares of Microsoft,” . . . on the internal queue.

Once the action is placed on the internal queue, those actions requiring orders, e.g. “Buy 10,000 shares of Sun; sell 15,000 shares of Microsoft to the ordering system,” send the orders to the ordering system by way of an ActionDispatcher. The order may be sent to any specific ordering system in the various preferred embodiments, and the specific ordering system that the order is sent to will depend upon the interface configuration.

After the ordering system executes the orders, it will send the execution confirmation to the input driver. If, instead of execution, the order has been cancelled or corrected by the ordering system, the ordering system will send the appropriate message to the Input driver.

Isolating the execution of the actions by means of the ActionDispatcher helps prevent more than one action from the same ComplexOrder executing simultaneously, which is important to accurate execution. For example, if actions did execute simultaneously, there might be an out-of-order result fed back to the ComplexOrder, leading to incorrect execution of the order.

Once the order has been executed by the ordering system, an Order message is fed back to the Exchange driver. The Exchange driver will then create an ExchangeEvent object, which will be disseminated through the Core Processing Area. In an especially preferred embodiment, the ExchangeEvent object is sent to a market gateway component, which creates a SysAction object, to be used internally to update an associated AlgorithmContext object. Of course, it would be possible, in some embodiments, to update the AlgorithmContext object directly. However, the preferred embodiments use of an indirect transfer for the order message helps ensure accuracy in the ordering mechanism by preventing interference with any possible action execution.

The SysAction object is used internally to update the AlgorithmContext object by way of the ActionDispatcher. The ActionDispatcher will also provide any other Event interests with the SysAction object, provided they had registered an interest with that particular AlgorithmContext. When the SysAction object informs the AlgorithmContext object the Actions have been completed (which may include notification of execution, failure to execute, etc.), the AlgorithmContext fires a CloseAction instance. In some preferred embodiments, this will close the order. In other embodiments, the CloseAction instance will trigger a message to the ordering system, which will close the order according to its mechanisms.

The preferred embodiments are not immune from system crashes and therefore the preferred embodiments attempt to ensure accuracy in order tracking and execution by isolating actions through queues and messaging. Moreover, objects, if tracked, can be recreated if the system crashes. SysAction objects, if created, are saved in a journal. If a crash occurs, and upon restarting, the Core Processing Area scans the journal, effectively as an input stream, reading in each SysAction object and providing whatever executions are necessary. This will have the effect of re-creating the order hierarchy as it was before the crash. Additionally, the preferred embodiments use an initialization recovery flag set by the AlgorithmContext object at the beginning of its instantiation. This recovery flag allows for the tracking of and thus re-creation of any registered event interests, as well as initialization and recovery of the order after a crash and subsequent system recovery.

The preferred embodiments also create an image file on a regular basis, perhaps at intervals as short as an hour or so. Every interval, the complete order state is dumped to two alternate mirror image files, which provides backup and possible replacement for the journal. The image files retain an order hierarchy and this hierarchy can be read post crash if necessary. The journal file will then provide the latest update.

The sophistication of the system makes constant testing necessary. Testing can occur through trader feedback, evolution and updating of an algorithm once it is in production. Simulated information feeds cast also be used, in the preferred embodiments, to test the system.

The above description and the views and material depicted by the figures are for purpose of illustration only and are not intended to be, and should not be construed as, limitations on the invention.

Moreover, certain modifications or alternatives may suggest themselves to those skilled in the an upon reading of this specification, all of which are intended to be within the spirit and scope of the present invention as defined in the attached claims.

1-8. (canceled)

9. A computer-assisted trading method, comprising:
identifying a market plug-in that defines a set of market-specific rules to use for trades in a corresponding market;
providing a graphical user interface at a client device, the graphical user interface configured to enable a trader to define parameters for a trading plug-in;
creating the trading plug-in based on parameters provided by the trader via the graphical user interface, the trading plug-in including a trading algorithm parameterized by the parameters;
receiving market information for the market corresponding to the market plug-in;
applying the market-specific rules and the trading algorithm to the market information to identify a set of orders; and
implementing the identified set of orders by making trades in the corresponding market.

10. The method of claim 9, wherein identifying the market plug-in comprises:
providing a list identifying a plurality of market plug-ins for display to the trader; and
receiving an identifier of the market plug-in from the client device responsive to selection of the market plug-in by the trader.

11. The method of claim 9, wherein the market plug-in remains unchanged for a predetermined period of time.

12. The method of claim 9, wherein the graphical user interface includes a control for selecting an algorithm context and a control for selecting a set of event-action mappings, wherein the algorithm context is preprogrammed by a programmer and the set of event-action mappings are configurable by the trader via the graphical user interface.

13. The method of claim 9, wherein applying the market-specific rules and the trading algorithm to the market information to identify the set of orders comprises:
identifying a recommended set of orders using the market-specific rules and the trading algorithm;
providing the recommended set of orders for display to the trader in the graphical user interface;
receiving trader input requesting a modification to the recommended set of orders; and
modifying the recommended set of orders based on the trader input to generate the set of orders.

14. The method of claim 9, wherein the set of orders comprises a complex order that includes a condition and a plurality of trades.

15. The method of clam 14, wherein implementing the identified set of orders comprises:
detecting, based on a market data feed, that the condition is currently met;
breaking down the complex order into a plurality of simple orders, each simple order including a corresponding one of the plurality of trades; and
implementing the plurality of simple orders by making the corresponding trades in the corresponding market.

16. The method of claim 14, wherein implementing the identified set of orders comprises:
instantiating an event interest object configured to monitor a market data stream for the condition being met;
in response to the event tracker object determining that the condition is currently met, generating an event notification; and
in response to the event notification, making the plurality of trades in the corresponding market.

17. The method of claim 9, further comprising:
adding the set of orders to a journal file prior to implementing the set of orders; and
in response to recovering from a system crash:
retrieving the set order from the journal file;
determining which orders from the set of orders have been implemented; and
applying the market-specific rules and the trading algorithm to updated market information to identify an updated set of orders.

18. A non-transitory computer-readable medium storing instructions that, when executed by one or more processors, cause the one or more processors to perform operations including:
identifying a market plug-in that defines a set of market-specific rules to use for trades in a corresponding market;
providing a graphical user interface at a client device, the graphical user interface configured to enable a trader to define parameters for a trading plug-in;
creating the trading plug-in based on parameters provided by the trader via the graphical user interface, the trading plug-in including a trading algorithm parameterized by the parameters;
receiving market information for the market corresponding to the market plug-in;
applying the market-specific rules and the trading algorithm to the market information to identify a set of orders; and
implementing the identified set of orders by making trades in the corresponding market.

19. The non-transitory computer-readable medium of claim 18, wherein identifying the market plug-in comprises:
providing a list identifying a plurality of market plug-ins for display to the trader; and
receiving an identifier of the market-plug-in from the client device responsive to selection of the market plug-in by the trader.

20. The non-transitory computer-readable medium of claim 18, wherein the graphical user interface includes a control for selecting an algorithm context and a control for selecting a set of event-action mappings, wherein the algorithm context is preprogrammed by a programmer and the set of event-action mappings are configurable by the trader via the graphical user interface.

21. The non-transitory computer-readable medium of claim 18, wherein applying the market-specific rules and the trading algorithm to the market information to identify the set of orders comprises:
identifying a recommended set of orders using the market-specific rules and the trading algorithm;
providing the recommended set of orders for display to the trader in the graphical user interface;
receiving trader input requesting a modification to the recommended set of orders; and
modifying the recommended set of orders based on the trader input to generate the set of orders.

22. The non-transitory computer-readable medium of claim 18, wherein the set of orders comprises a complex order that includes a condition and a plurality of trades.

23. The non-transitory computer-readable medium of claim 22, wherein implementing the identified set of orders comprises:
detecting, based on a market data feed, that the condition is currently met;
breaking down the complex order into a plurality of simple orders, each simple order including a corresponding one of the plurality of trades; and
implementing the plurality of simple orders by making the corresponding trades in the corresponding market.

24. The non-transitory computer-readable medium of claim 22, wherein implementing the identified set of orders comprises:
instantiating an event interest object configured to monitor a market data stream for the condition being met;
in response to the event tracker object determining that the condition is currently met, generating an event notification; and
in response to the event notification, making the plurality of trades in the corresponding market.

25. The non-transitory computer-readable medium of claim 18, wherein the operations further include:
adding the set of orders to a journal file prior to implementing the set of orders; and in response to recovering from a system crash:
retrieving the set order from the journal file;
determining which orders from the set of orders have been implemented; and
applying the market-specific rules and the trading algorithm to updated market information to identify an updated set of orders.

26. A computer-implemented transaction system, comprising
one or more processors; and
one or more computer-readable media storing instructions that, when executed by the one or more processors, cause the one or more processors to perform operations including:
identifying a market plug-in that defines a set of market-specific rules to use for trades in a corresponding market;
providing a graphical user interface at a client device, the graphical user interface configured to enable a trader to define parameters for a trading plug-in;
creating the trading plug-in based on parameters provided by the trader via the graphical user interface, the trading plug-in including a trading algorithm parameterized by the parameters;
receiving market information for the market corresponding to the market plug-in;
applying the market-specific rules and the trading algorithm to the market information to identify a set of orders; and
implementing the identified set of orders by making trades in the corresponding market.

27. The computer-implemented transaction system of claim 26, wherein the graphical user interface includes a control for selecting an algorithm context and a control for selecting a set of event-action mappings, wherein the algorithm context is preprogrammed by a programmer and the set of event-action mappings are configurable by the trader via the graphical user interface.

28. The computer-implemented transaction system of claim 26, wherein applying the market-specific rules and the trading algorithm to the market information to identify the set of orders comprises:
identifying a recommended set of orders using the market-specific rules and the trading algorithm;
providing the recommended set of orders for display to the trader in the graphical user interface;
receiving trader input requesting a modification to the recommended set of orders; and
modifying the recommended set of orders based on the trader input to generate the set of orders.
